(19) United States
(12) Patent Application Publication
(10) Pub. No.: US 2011/0037185 A1
(43) Pub. Date: Feb. 17, 2011

(54) CONTINUOUS PROCESS FOR MAKING PHARMACEUTICAL COMPOSITIONS

(76) Inventors: James Kowalski, Belle Mead, NJ (US); Jay P. Lakshman, Bridgewater, NJ (US); Abu T.M. Serajuddin, Queens, NY (US); Wei-Qin Tong, Basking Ridge, NJ (US); Madhav Vasanthavada, Basking Ridge, NJ (US)

Correspondence Address: NOVARTIS;CORPORATE INTELLECTUAL PROPERTY, ONE HEALTH PLAZA 101/2, EAST HANOVER, NJ, 07936-1080, US

(21) Appl. No.: 12/990,151

(22) PCT Filed: Apr. 29, 2009
(86) PCT No.: PCT/US09/42050

§ 371 Date: Oct. 28, 2010

Related U.S. Application Data
(60) Provisional application No. 61/049,088, filed on Apr. 30, 2008.

(51) Int. Cl. B29B 9/08

(52) U.S. Cl. 264/6

(57) ABSTRACT

A process for manufacturing solid oral dosage forms in an equipment train that comprises multiple pieces of apparatus designed for unit operations, such as blending, extruding, cooling, milling and finishing. The equipment in the equipment train allow for the transfer of raw materials and intermediate-processed materials from one apparatus to the next using transfer means, for example, gravity, vacuum, belts, and the like.

### FIELD OF THE INVENTION

The present invention relates to a continuous process for the manufacture of solid oral dosage form pharmaceutical compositions. The continuous process features an equipment train that includes, among other pieces of equipment, an extruder, mill, and blender. The pharmaceutical ingredients are conveyed from one piece to the next using various transfer means.

### BACKGROUND OF THE INVENTION

Oral pharmaceutical products, e.g., tablets and capsules are often manufactured in a batch processing manner. this means that the drug products are made according to a single manufacturing order during the same cycle of manufacture. The general process of manufacturing includes a series of unit operations. Such operations may include, for example, blending, granulating comminutating, and tableting. Batch processing may result in lower output quality/quantity, lesser flexibility and higher labour costs when compared to other manufacturing techniques.

In contrast, continuous manufacturing allows for the manufacturing of end products from raw materials in a single continuous fashion such as the output is maintained at a consistent rate. Continuous manufacturing is often used in non-pharmaceutical industries, such as the chemical, food and electronics industries.

The present invention features a process of manufacturing a solid oral dosage form in a single pass, fully automated, continuous process that can handle very small to very large batch sizes. The inventive process features the use of an extruder as a continuous wet granulator and/or continuous melt granulator. Such use of an extruder avoids separate unit operates such as blending, granulating and drying. In line with the extruder can be, for example, a continuous blender and a tablet press or encapsulator. Thus the result of the present invention is a concatenation of a chain of independent unit operations into a single equipment train that starts with raw materials and ends with a solid oral dosage form.

### SUMMARY OF THE INVENTION

The present invention features a continuous manufacturing process to make solid oral dosage forms. The process features the use of an extruder in line with a mill, a blender and a tablet press or encapsulator. The pharmaceutical materials, for example a therapeutic compound and pharmaceutically acceptable excipient are introduced into an extruder for granulation. The extruder can be configured for melt granulation or wet granulation. The output of the extrude, extrudates, are transferred to an optional cooling tower. The cooling tower cools the extrudates and allows them to further harden. Once cooled, the extrudates may be transferred to an in-line mill for milling into granules. The granules can then be processed with additional pharmaceutically acceptable excipients to form a blend that is suitable for tableting, encapsulating or finishing into another solid oral dosage form, for example a sachet. The entire process is a single continuous process that uses transfer means to move the materials from one unit operation equipment to the next. Particularly useful as transfer means is gravity.

It should be understood that throughout this specification and in the claims that follow, unless the context requires otherwise, the word “comprise”, or variations such as “comprises” or “comprising”, implies the inclusion of the stated integer or step, or group of integers or steps.

### BRIEF DESCRIPTION OF THE DRAWINGS

The accompanying drawings, which are incorporated in and constitute a part of the specification, illustrate an exemplary embodiment of the present invention.

FIG. 1 depicts a schematic showing exemplary unit operation equipment aligned to form an equipment train 10 that is appropriate for a continuous manufacturing.

### DETAILED DESCRIPTION OF THE INVENTION

The present invention relates to a continuous process for preparing solid oral dosage form pharmaceutical compositions from raw materials in a single equipment train.

As used herein the term “unit operation” refers to a step or process in the manufacture of drug products as employed in batch processing. Examples of unit operations includes, but not limited to: weighing, blending, mixing, granulating, drying, communitating, milling, coating, tableting, compressing, encapsulating, sieving, embossing, stamping, packaging. Such unit operation when conducted in batch processing may be accomplished by a single-piece or multiple-piece unit operation equipment. For example, a ribbon blender, as known to one of ordinary skill in the art, is an example of unit operation equipment for mixing.

As used herein the term “equipment train” refers to the individual and independent pieces of unit operation equipment that are linked together. The individual unit operation equipment are linked to each other in a manner such that the pharmaceutical materials (i.e. the raw materials, intermediate drug products and final drug product) is continuously conveyed from one piece of unit operation equipment to the next piece of unit operation equipment without any mandatory intervention from the equipment operator.

As used herein the term “transfer means” refers to any means able to transfer the pharmaceutical components from one piece of the equipment train to another piece and any equipment necessary to effect such a transfer, for example conduits or belts. Examples of transfer Means includes, but not limited, vacuum, gravity, conveyor belts, vibratory belts and bucket belts. The transfer means does not contemplate the use of any intervention or assistance from a human operator of the equipment train.

As used herein the term “pharmaceutical composition” means a mixture containing a therapeutic compound to be administered to a mammal, e.g., a human in order to prevent, treat or control a particular disease or condition affecting the mammal.

As used herein the term “pharmaceutically acceptable” refers to those compounds, materials, compositions and/or dosage forms, which are, within the scope of sound medical judgment, suitable for contact with the tissues of mammals, especially humans, without excessive toxicity, irritation, allergic response and other problem complications commensurate with a reasonable benefit/risk ratio.

As used herein the term “therapeutic compound” means any compound, substance, drug, medicament, or active ingredient having a therapeutic or pharmacological effect, and which is suitable for administration to a mammal, e.g., a human, in a composition that is particularly suitable for oral administration. As contemplated in the present invention, a therapeutic compound may be a single therapeutic compound or refer to multiple therapeutic compounds in combination.

The therapeutic compound(s) is present in the pharmaceutical compositions of the present invention in a therapeutically effective amount or concentration. Such a therapeutically effective amount or concentration is known to one of ordinary skill in the art as the amount or concentration varies with the therapeutic compound being used and the indication which is being addressed. For example, in accordance with the present invention, the therapeutic compound may be present in an amount by weight of about 0.05% to about 99% weight of pharmaceutical composition. In one embodiment, the therapeutic compound may be present in an amount by weight of about 10% to about 95% by weight of the pharmaceutical composition.

Examples of pharmaceutically acceptable excipients include, but are not limited to, release retardants, plasticizers, disintegrants, binders, lubricants, glidants, stabilizers, fillers and diluents. One of ordinary skill in the art may select one or more of the aforementioned excipients with respect to the particular desired properties of the solid oral dosage form by routine experimentation and without any undue burden. The amount of each excipient used may vary within ranges conventional in the art. The following references which are all hereby incorporated by reference disclose techniques and excipients used to formulate oral dosage forms. See The Handbook of Pharmaceutical Excipients, 4th edition, Rowe et al., Eds., American Pharmaceuticals Association (2003); and Remington: the Science and Practice of Pharmacy, 2oth edition, Gennaro, Ed., Lippincott Williams & Wilkins (2003).

Examples of pharmaceutically acceptable disintegrants include, but are not limited to, starches; clays; celluloses; alginates; gums; cross-linked polymers, e.g., cross-linked polyvinyl pyrrolidone or crospovidone, e.g., POLYPLASDONE XL from International Specialty Products (Wayne, N.J.); cross-linked sodium carboxymethylcellulose or croscarmellose sodium, e.g., AC-Dl-SOL from FMC; and cross-linked calcium carboxymethylcellulose; soy polysaccharides; and guar gum. The disintegrant may be present in an amount from about 0% to about 10% by weight of the composition. In one embodiment, the disintegrant is present in an amount from about 0.1% to about 1.5% by weight of composition.

Examples of pharmaceutically acceptable binders include, but are not limited to, starches; celluloses and derivatives thereof, for example, microcrystalline cellulose, e.g., AVICEL PH from FMC (Philadelphia, Pa.), hydroxypropyl cellulose hydroxylethyl cellulose and hydroxylpropylmethyl cellulose METHOCEL from Dow Chemical Corp. (Midland, Mich.); sucrose; dextrose; corn syrup; polysaccharides; and gelatin. The binder may be present in an amount from about 0% to about 50%, e.g., 10-40% by weight of the composition.

Examples of pharmaceutically acceptable lubricants and pharmaceutically acceptable glidants include, but are not limited to, colloidal silica, magnesium trisilicate, starches, talc, tribasic calcium phosphate, magnesium stearate, aluminum stearate, calcium stearate, magnesium carbonate, magnesium oxide, polyethylene glycol, powdered cellulose and microcrystalline cellulose. The lubricant may be present in an amount from about 0% to about 10% by weight of the composition. In one embodiment, the lubricant may be present in an amount from about 0.1% to about 1.5% by weight of composition. The glidant may be present in an amount from about 0.1% to about 10% by weight.

Examples of pharmaceutically acceptable fillers and pharmaceutically acceptable diluents include, but are not limited to, confectioner's sugar, compressible sugar, dextrates, dextrin, dextrose, lactose, mannitol, microcrystalline cellulose, powdered cellulose, sorbitol, sucrose and talc. The filler and/or diluent, e.g., may be present in an amount from about 15% to about 40% by weight of the composition.

As used herein the term “raw material” means a therapeutic compound, a pharmaceutically acceptable excipient or a mixture of the foregoing.

As used herein the term “end product” means a solid oral dosage form. Examples of solid oral dosage forms includes, but are not limited to, tablets, pills, lozenges, caplets, capsules or sachets.

The inventive process utilizes an equipment train that features various pieces of equipment for unit operations linked together via transfer means. Raw materials are introduced into the equipment train, and the final output is an end product.

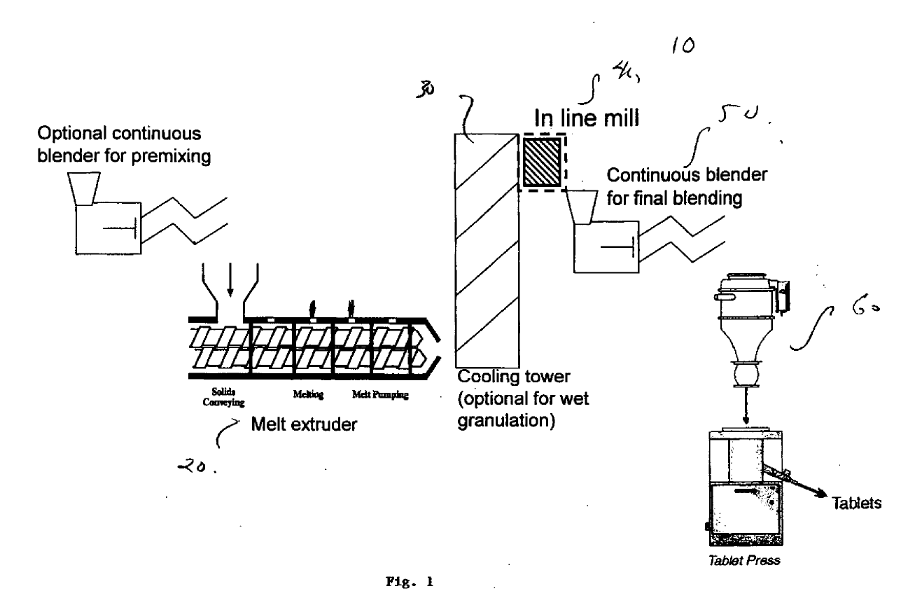

FIG. 1 shows an exemplary equipment train 10 with six pieces of equipment performing different unit operations. Each piece of equipment has an input and output. With the exception of the first piece of equipment, the outlet of each equipment is in proximity to the input of the next piece of equipment such that transfer Means may be used to transfer material from a piece of equipment to the subsequent piece of equipment.

The centerpiece of the inventive process of the present invention is an extruder. In general, an extruder includes a rotating screw(s) within a stationary barrel with an optional die located at one end of the barrel. Along the entire length of the screw, distributive kneading of the materials (e.g., the therapeutic compound, release retarding material, and any other needed excipients) is provided by the rotation of the screw(s) within the barrel.

Conceptually, the extruder can be divided into at least three sections: a feeding section; a heating section and a metering section. In the feeding section, the raw materials are fed into the extruder, e.g. from a hopper. In the heating section, the raw materials are heated to a temperature. After the heating section is a metering section in which the mixed materials are extruded through an optional die into a particular shape, e.g., granules or noodles. Types of extruders particularly useful in the present invention are single-, twin- and multi-screw extruders, optionally configured with kneading paddles.

The extruders appropriate for the present invention may be commercially supplied by Leistriz or ThermoPrism. For example, a 50 mm twin screw extruder that blends materials at a 100 kg 1 hour may be suitable. In FIG. 1, the extruder is shown as 20.

Depending on how the extruder 20 is configured and what processing aids are present in the extruder 20, the extruder may be used for melt granulation or wet granulation. For instance, melt granulation may be appropriate for use with moisture sensitive therapeutic compounds or end products that require high therapeutic concentrations, or loads. Wet granulation may be suitable for therapeutic compounds that are thermolabile. In the event that wet granulation is desired, a granulating fluid such as water may be introduced into the extruder.

Located upstream in the equipment train 10, that is located towards the front in which raw materials first enter the equipment train, is an optional continuous blender 10 for premixing.

Raw materials, for example the therapeutic compound and at least one pharmaceutically acceptable excipient may be first preblended by the continuous blender 10 prior to entering the extruder 20. For example, if the therapeutic compound and the pharmaceutically acceptable excipient are needed in such small quantities that the feeder of an extruder could not accurately feed or measure at slow rates, then pre-blending with a continuous blender may be appropriate. Another scenario in which preblending may facilitate the downstream manufacturing is if the extruder rate will be set at less than one gram per hour. Having a preblending step allows for bulking up the mixture. Furthermore, if the therapeutic compound and the pharmaceutically acceptable excipient are poorly flowing materials, for example micronized materials, preblending may be suitable.

As shown in FIG. 1, after the extruder 20 is an optional cooling tower 30. A cooling tower 30 may be used for moisture labile therapeutic compounds. Additionally, if solid dispersions of the therapeutic compound and pharmaceutically acceptable excipient(s) are being formed from the extruder 20, then a cooling tower 30 may be used. An exemplary cooling tower 30 may incorporate belt conveyors with fan-cooling or chilled-water cooling. Alternatively, a cooling tower 30 may include a spiral conveyor to allow for a smaller footprint. Choice of a specific type of cooling tower would be known by one of ordinary skill in the art. Factors for choosing include the heat capacity of the hot materials to be cooled as well as the rate in which such materials are to be cooled.

After the cooling tower 30, of directly after the melt extruder 20 if no cooling tower is used, is a mill 40. The mill 40 grinds the existing extrudates to specific particle sizes, for example between fifty and one-hundred and fifty microns. The residence time in the mill may be for any suitable period to achieve the desired particle size, for example five minutes or less.

Once milled, the extrudate may be optionally incorporated with additional pharmaceutically acceptable excipients in a continuous blender 50 for final blending.

Examples of pharmaceutically acceptable excipients that may be appropriate for this unit operation include, but are not limited to glidants, disintegrants and lubricants. The residence time in a continuous blender, for instance, may be between five to ten minutes with a rate of ten rpms.

The next piece of equipment in the exemplary equipment train 10 of FIG. 1 is tablet press 60. Any type of tablet press as known by one of ordinary skill in the art may be used in the present invention. Examples of such tablet presses include, but are not limited to, low or high-speed presses, single/bi multilayer presses, and tablet-in-tablet presses. Tablet presses use forces between two and ninety kN to compress the milled materials.

Alternatively, in lieu of a tablet press 60, encapsulators may be used to form capsule.

Examples of encapsulators include, but are not limited to vacuum, gravity or displacement based encapsulators.

An exemplary process which may be used on the exemplary equipment train includes the following steps. Any of the following steps, unit operations, may be rendered optional depending on the specific circumstances of the manufacturing process.
(a) forming a preblend from a mixture of raw materials, i.e., a therapeutic compound and at least one pharmaceutically acceptable excipient in a continuous blender, or alternatively directly feeding the raw materials into an extruder;
(b) combining or granulating the raw materials to form agglomerates or a solid dispersion in the extruder;
(c) extruding the agglomerates or solid dispersion into extrudates;
(d) cooling the extrudates in a cooling tower;
(e) milling the extrudates into particulates or granules;
(f) combining the particulates with at least one additional pharmaceutically acceptable excipient to form a blend in a blender; and
(g) finishing the blend into a solid oral dosage form using tableting or encapsulating equipment.

As the raw materials are converted in the various unit operations equipment, the materials are transferred from one piece of equipment to the next via transfer means.

The final result in a continuous process that allows for the feeding of raw materials into the equipment train upstream and having a solid oral dosage form produced downstream.

The following examples are illustrative, but do not serve to limit the scope of the invention described herein. The examples are meant only to suggest a method of practicing the present invention.

For example an exemplary equipment train can comprise the following pieces of equipment: a twin screw extruder; an in-line mill; a ribbon blender; and a rotary tablet press (which is a finished solid oral dosage form apparatus). The raw materials, for example a therapeutic compound, a binder and a disintegrant may be directly fed into the twin screw extruder which blends the raw materials and extrudes an extrudate. The output port of the extruder may be placed in a position relative to the intake of an in-line mill such that the extrudate falls by gravity into an intake of the in line mill. Once again, by gravity, the milled particulates may be directly fed from the output of the mill into the hopper of a ribbon blender. Also fed into the hopper may be other pharmaceutically acceptable excipients such as a lubricant and a binder. Once thoroughly blended, the blended material may be fed once again, via gravity, into the hopper of a rotary tablet press for compression into tablets.

It is understood that while the present invention has been described in conjunction with the detailed description thereof that the foregoing description is intended to illustrate and not limit the scope of the invention, which is defined by the scope of the following claims. Other aspects, advantages and modification are within the scope of the claims.

1-7. (canceled)

8. A continuous process for the manufacture of a solid oral dosage form comprising the steps of: introducing at least one therapeutic compound and at least one pharmaceutically acceptable ingredient into an extruder; combining the therapeutic compound and the at least one pharmaceutically acceptable ingredient into a mixture using a melt granulation process; extruding the mixture from the extruder; using a first transfer means to transfer the extrudate from the extruder into a mill; milling the extrudate into granules; using a second transfer means to transfer the granules into a blender; using a third transfer means to transfer the blended granules into a finished solid oral dosage form apparatus.

9. The process of claim 8, wherein the first transfer means is gravity.

10. The process of claim 8, in which the solid oral dosage form end products have high therapeutic concentrations, or loads.

11. The process of claim 8, further comprising cooling the extrudates in a cooling tower.

12. The process of claim 8, further comprising blending the therapeutic compound and the pharmaceutically acceptable excipient into a preblend prior to introducing into the extruder.

13. The process claim 8, wherein the finished solid oral dosage form apparatus is a tablet press.

14. The process of any of claims 8, wherein the finished solid oral dosage form apparatus is an encapsulator.
